(19) United States
(12) Patent Application Publication
(10) Pub. No.: US 2011/0161435 A1
(43) Pub. Date: Jun. 30, 2011

(54) SYSTEM AND METHOD FOR DEFERRED TRANSMISSION OF ATTACHMENTS

(76) Inventor: Patrick Charles Mancuso, Center Tuftonboro, NH (US)

(21) Appl. No.: 12/650,879

(22) Filed: Dec. 31, 2009

(51) Int. Cl. G06F 15/16

(52) U.S. Cl. 709/206; 709/207

(57) ABSTRACT

A first message may be received, wherein the first message may include a message body and an attachment. The first message may be processed to generate at least a second and a third message, wherein the second message may be generated based, at least in part, upon the message body and the third message may be generated based, at least in part, upon the attachment. A delay may be calculated based, at least in part, upon a network condition level. The second message may be transmitted. The third message may be transmitted based, at least in part, upon the calculated delay.

### TECHNICAL FIELD

This disclosure relates to transmission of attachments and, more particularly, to a method of deferred transmission of attachments.

### BACKGROUND

Conventional systems for transmitting attachments generally allow users/computing systems to transmit attachments essentially simultaneously with an accompanying message, or to delay the transmission of the message in its entirety. Users/computing systems may typically wish to deliver a portion of a message that may be of a different relative importance than another portion. Often, this may be due to a desire to reduce the demands on network bandwidth.

### SUMMARY OF DISCLOSURE

In a first implementation, a computer program product includes a computer readable medium having a plurality of instructions stored on it. When executed by a processor, the instructions cause the processor to perform operations including receiving at least a first message, wherein the first message includes a message body and an attachment. The first message is processed to generate at least a second and a third message, wherein the second message is generated based, at least in part, upon the message body and the third message is generated based, at least in part, upon the attachment. A delay is calculated based, at least in part, upon a network condition level. The second message is transmitted. The third message is transmitted based, at least in part, upon the calculated delay.

One or more of the following features may be included. At least the first message may include a priority tag. Transmitting the third message may be based, at least in part, upon the priority tag. Processing the first message to generate the at least the second and the third message may further include generating one or more placeholders based, at least in part, upon the third message, and modifying the second message to include the one or more placeholders. The one or more placeholders may be modified to indicate an availability of the third message. Calculating the delay may include calculating the delay based upon, at least in part, a fixed schedule. Calculating the delay may include calculating the delay based upon, at least in part, a minimum transmission limit.

According to another implementation, a computing system includes a processor and a memory module coupled with the processor. A first software module is executable by the processor and the memory module. The first software module is configured to receive at least a first message, wherein the first message includes a message body and an attachment. A second software module is executable by the processor and the memory module. The second software module is configured to process the first message to generate at least a second and a third message, wherein the second message is generated based, at least in part, upon the message body and the third message is generated based, at least in part, upon the attachment. A third software module is executable by the processor and the memory module. The third software module is configured to calculate a delay based, at least in part, upon a network condition level.

A fourth software module is executable by the processor and the memory module. The fourth software module is configured to transmit the second message. A fifth software module is executable by the processor and the memory module. The fifth software module is configured to transmit the third message based, at least in part, upon the calculated delay.

One or more of the following features may be included. At least the first message may include a priority tag. Transmitting the third message may be based, at least in part, upon the priority tag. Processing the first message to generate the at least the second and the third message may further include generating one or more placeholders based, at least in part, upon the third message, and modifying the second message to include the one or more placeholders. The one or more placeholders may be modified to indicate an availability of the third message. Calculating the delay may include calculating the delay based upon, at least in part, a fixed schedule. Calculating the delay may include calculating the delay based upon, at least in part, a minimum transmission limit.

According to yet another implementation, a computer implemented method includes receiving at least a first message, wherein the first message includes a message body and an attachment. The first message is processed to generate at least a second and a third message, wherein the second message is generated based, at least in part, upon the message body and the third message is generated based, at least in part, upon the attachment. A delay is calculated based, at least in part, upon a network condition level. The second message is transmitted. The third message is transmitted based, at least in part, upon the calculated delay.

One or more of the following features may be included. At least the first message may include a priority tag. Transmitting the third message may be based, at least in part, upon the priority tag. Processing the first message to generate the at least the second and the third message may further include generating one or more placeholders based, at least in part, upon the third message, and modifying the second message to include the one or more placeholders. The one or more placeholders may be modified to indicate an availability of the third message. Calculating the delay may include calculating the delay based upon, at least in part, a fixed schedule. Calculating the delay may include calculating the delay based upon, at least in part, a minimum transmission limit.

The details of one or more implementations are set forth in the accompanying drawings and the description below. Other features and advantages will become apparent from the description, the drawings, and the claims.

### BRIEF DESCRIPTION OF THE DRAWINGS

FIG. 1 diagrammatically depicts a transmission process coupled to a distributed computing system.

FIG. 2 is a flow chart of a process performed by the transmission process of FIG. 1.

FIG. 3 diagrammatically depicts a message received by the transmission process of FIG. 1.

FIG. 4 diagrammatically depicts a message transmitted by the transmission process of FIG. 1.

FIG. 5 diagrammatically depicts a message transmitted by the transmission process of FIG. 1.

### DETAILED DESCRIPTION OF EXEMPLARY EMBODIMENTS

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

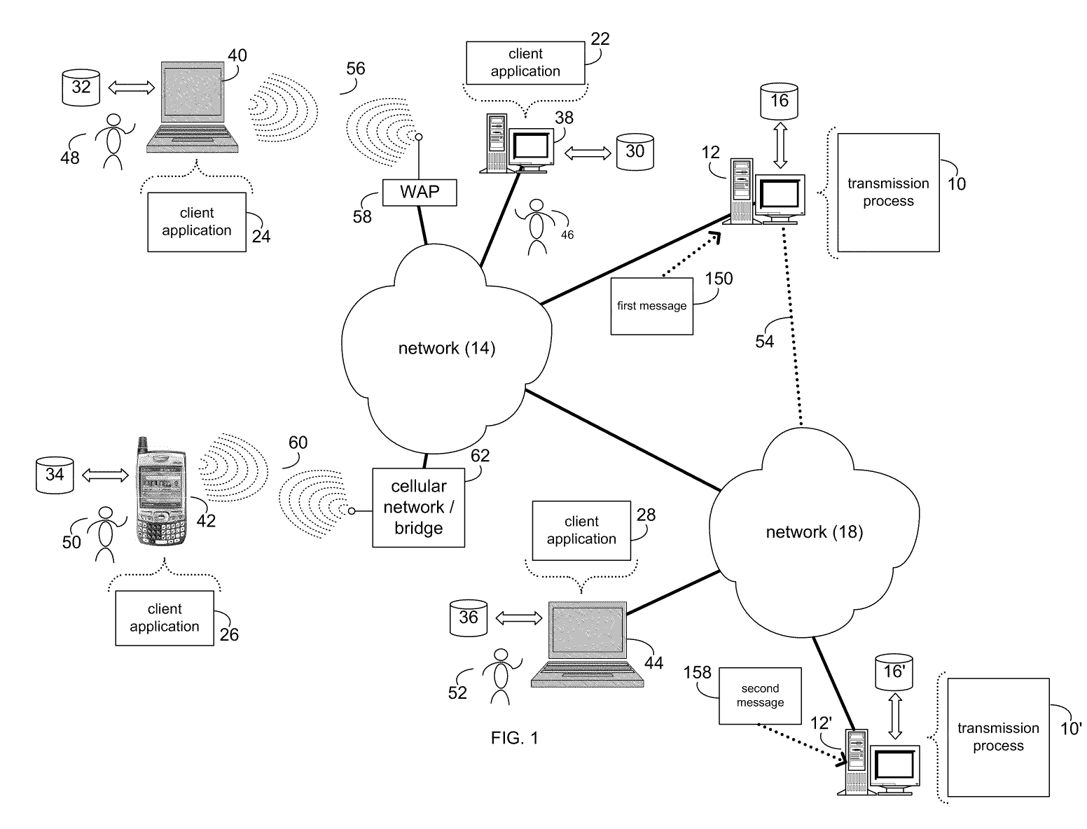

Referring to FIG. 1, there is shown transmission process 10 and transmission process 10′ that may reside on and may be executed by server computer 12 and server computer 12′ (respectively), which may be connected to network 14 (e.g., the Internet or a local area network) and/or network 18. Examples of server computer 12/12′ may include, but are not limited to: a personal computer, a server computer, a series of server computers, a mini computer, and a mainframe computer. Server computer 12 may be a web server (or a series of servers) running a network operating system, examples of which may include but are not limited to: Microsoft® Windows® XP Server; Novell® Netware®; or Red Hat® Linux®, for example (Microsoft and Windows are registered trademarks of Microsoft Corporation in the United States, other countries, or both; Novell and NetWare are registered trademarks of Novell Corporation in the United States, other countries, or both; Red Hat is a registered trademark of Red Hat Corporation in the United States, other countries, or both; and Linux is a registered trademark of Linus Torvalds in the United States, other countries, or both).

In addition/as an alternative to being a server-based application residing on server computer 12/12′, transmission process 10/10′ may be a client-side application residing on one or more client electronic devices 38, 40, 42, 44 (e.g., stored on storage devices 30, 32, 34, 36, respectively). As a client-side application, transmission process 10 may, e.g., be a stand alone application, interface with a server, or may be an applet/application that is executed within a related application. Accordingly, transmission process 10/10′ may be a server-based process, a client-side process and/or may be a hybrid client-side/server-based process, which may be executed, in whole or in part, by a client application and by a server application.

The instruction sets and subroutines of transmission process 10/10′, which may be configured as one or more software modules, and which may be stored on storage device 16/16′ coupled to server computer 12/12′, may be executed by one or more processors (not shown) and one or more memory modules (not shown) incorporated into server computer 12/12′. Storage device 16/16′ may include but is not limited to: a hard disk drive; a solid state drive; a tape drive; an optical drive; a RAID array; a random access memory (RAM); and a read-only memory (ROM).

Server computer 12/12′ may execute a server application, examples of which may include but are not limited to: IBM® Lotus® Domino®. Network 14 may be connected to one or more secondary networks (e.g., network 18), examples of which may include but are not limited to: a local area network; a wide area network; or an intranet, for example.

The instruction sets and subroutines of client applications 22, 24, 26, 28, which may be configured as one or more software modules, and which may be stored on storage devices 30, 32, 34, 36 (respectively) coupled to client electronic devices 38, 40, 42, 44 (respectively), may be executed by one or more processors (not shown) and one or more memory modules (not shown) incorporated into client electronic devices 38, 40, 42, 44 (respectively). Examples of client applications 22, 24, 26, 28 may include but are not limited to: email applications and file transfer applications.

Storage devices 30, 32, 34, 36 may include but are not limited to: hard disk drives; solid state drives; tape drives; optical drives; RAID arrays; random access memories (RAM); read-only memories (ROM), compact flash (CF) storage devices, secure digital (SD) storage devices, and memory stick storage devices. Examples of computing devices 38, 40, 42, 44 may include, but are not limited to, personal computer 38, laptop computer 40, personal digital assistant 42, notebook computer 44, a data-enabled, cellular telephone (not shown), and a dedicated network device (not shown), for example. Using client applications 22, 24, 26, 28, users 46, 48, 50, 52 may, for example, transmit messages that may include a message body and an attachment.

Users 46, 48, 50, 52 may access transmission process 10/10′ directly through the device on which the client application (e.g., client applications 22, 24, 26, 28) is executed, namely client electronic devices 38, 40, 42, 44, for example. Users 46, 48, 50, 52 may also access transmission process 10 directly through network 14 or through secondary network 18. Further, server computer 12/12′ (e.g., the computer that executes transmission process 10/10′) may be connected to network 14 through secondary network 18, as illustrated with phantom link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft® Windows®, Microsoft Windows CE®, Red Hat® Linux®, or a custom operating system (Windows CE is a registered trademark of Microsoft Corporation in the United States, other countries, or both).

For the purpose of the following description, client application 22 may be discussed. However, this is for illustrative purposes only and should not be construed as a limitation of the present disclosure, as other client applications (e.g., client applications 24, 26, 28) may be equally utilized. Additionally, and also for the purpose of the following description, messages may be referred to as email messages. However, this is for illustrative purposes only and should not be construed as a limitation of the present disclosure, as other messages may be equally utilized (e.g., documents managed by IBM® Lotus® Domino®).

Additionally/alternatively, documents being managed by a claim database may also be messages. For example, an automobile insurance claim database may be utilized to manage documents (e.g., claim records) that may have photographs included as attachments to the documents. As one of skill in the art will appreciate, the, e.g., automobile insurance claim database may communicate with other, e.g., replicas of that database and may transmit the messages (e.g., documents and attachments).

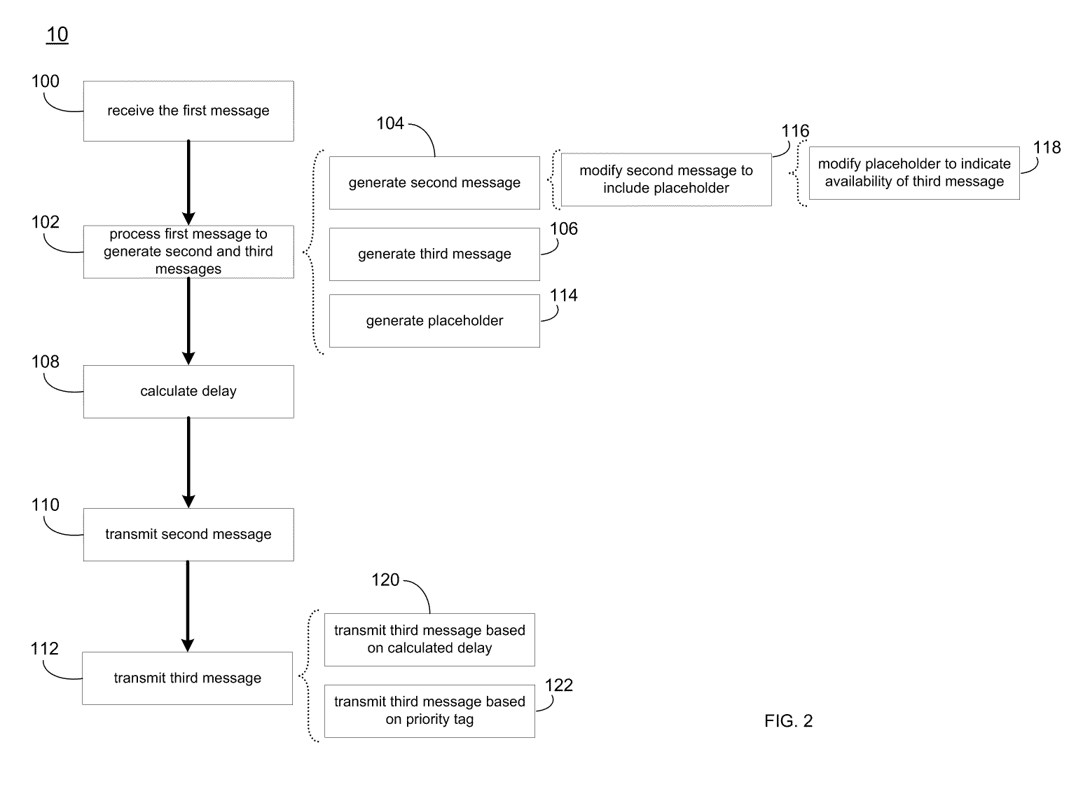

Referring also to FIG. 2, and as will be described in greater detail below, transmission process 10 may receive 100 at least a first message, wherein the first message may include a message body and an attachment. Transmission process 10 may process 102 the first message to generate at least a second and a third message, wherein the second message may be generated 104 based, at least in part, upon the message body and the third message may be generated 106 based, at least in part, upon the attachment. Transmission process 10 may calculate 108 a delay based, at least in part, upon a network condition level. Transmission process 10 may also transmit 110 the second message, and may transmit 112 the third message based, at least in part, upon the calculated delay.

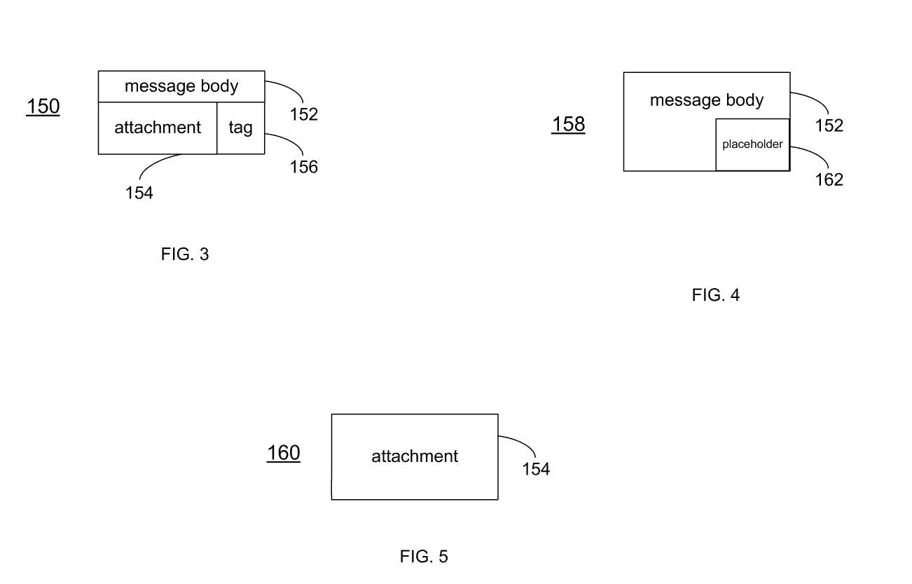

As stated above, and referring also to FIGS. 3-5, transmission process 10 may receive 100 at least first message 150, wherein first message 150 may include message body 152 and attachment 154. Examples of first message 150 may include but are not limited to: email messages. Similarly, examples of message body 152 and attachment 154 may include but are not limited to: email message bodies and email attachments (respectively). Additionally, first message 150 may include a priority tag (e.g., priority tag 156). As will be described in greater detail below, priority tag 156 may be utilized to indicate the eligibility (or lack thereof) of, e.g., attachment 154 to be transmitted on a delayed basis. Examples of such eligibility include but are not limited to: high-priority attachments, attachments of de minimus size, etc..

First message 150 may be processed 102 to generate 104 at least second message 158 and to generate 106 third message 160, wherein second message 158 may be generated 104 based, at least in part, upon message body 152 and third message 160 may be generated 106 based, at least in part, upon attachment 154. For example, transmission process 10, upon receiving 100 first message 150, may generate 104 second message 158, which generally may consist of message body 152 without attachment 154. This is not to be construed as a limitation of this disclosure, however, as second message 158 may also embody attachment 154.

Similarly, and upon receiving 100 first message 150, transmission process 10 may generate 106 third message 160, which generally may consist of attachment 154 without message body 152. This is not to be construed as a limitation of this disclosure, however, as third message 160 may also embody message body 152.

Processing 102 first message 150 to generate 104 at least second message 158 and to generate 106 at least third message 160 may further include generating 114 one or more placeholders 162 based, at least in part, upon third message 160. Placeholder 162 may, e.g., be utilized to indicate the existence of an attachment (e.g., attachment 154).

Further, processing 102 first message 150 to generate 104 at least second message 158 and to generate 106 at least third message 160 may also include modifying 116 second message 158 to include the one or more placeholders (e.g., placeholder 162).

As an illustrative example, assume that user 46 desires to transmit an email message (containing an attachment) to user 48. Further, assume that transmission process 10′ manages all email traffic for user 48. Accordingly, user 46 may utilize, e.g., client application 22 to create first message 150, which includes an attachment (e.g., attachment 154). Client application 22 (via, e.g., computing device 38 and network 14), may transmit first message 150 to transmission process 10 (e.g., residing on server computer 12). Upon receiving 100 first message 150, transmission process 10 may generate 114 placeholder 162 such that second message 158 may be modified 116 to include placeholder 162. As will be described in greater detail below, and upon receipt of second message 150, this may be useful to, e.g., indicate to transmission process 10′ (e.g., residing on server computer 12′) that attachment 154 does exist, but may not currently be available.

Additionally, the one or more placeholders (e.g., placeholder 162) may be modified 118 to indicate an availability of third message 160. Continuing with the above-stated example, and upon transmission 112 of third message 160 to transmission process 10′, transmission process 10′ may modify 118 placeholder 162 to indicate that third message 160 (e.g., containing attachment 154) is now available.

Transmission process 10 may calculate 108 a delay based, at least in part, upon a network condition level (not shown). For example, the network condition level may be based upon a level of network activity (e.g., low bandwidth availability may be experienced during high levels of network activity), transmission process 10 may calculate 108 a length of time (e.g., 10 seconds, 10 minutes, 2 hours, etc.) that third message 160 should be delayed in order to create the least amount of additional network traffic.

Transmission process 10 may also calculate 108 the delay based upon, at least in part, a fixed schedule (not shown). For example, transmission process 10 may utilize a fixed schedule that, e.g., corresponds to off-peak network usage times. Accordingly, transmission process 10 may calculate 108 the delay pursuant to a fixed schedule to effectuate transmission 112 of third message 160 during off-peak network usage times.

Additionally/alternatively, transmission process 10 may calculate 108 the delay such that a minimum transmission limit (not shown) is maintained. For example, transmission process 10 may calculate 108 the delay such that the transmission of, e.g., third message 160, may not be delayed indefinitely. This may require that transmission process 10 transmit 112 third message 160 during, e.g., peak network usage times if third message 160 may have been retained in a queue (not shown) in, e.g., server computer 12 for a predetermined amount of time.

Further, transmission process 10, e.g., may transmit 110 second message 158, regardless of the calculated 108 delay. For example, due to the heightened likelihood that second message 158 (e.g., embodying message body 152) may be of de minimus size (or may be of heightened importance relative to third message 160), transmission process 10 may transmit 110 second message 158 without delay. This is not to be construed as a limitation of this disclosure, however, as transmission process 10 may transmit 110 second message 158 pursuant to, e.g., the calculated 108 delay.

As described in detail above, transmission process 10 may then transmit 120 third message 150 based, at least in part, upon the calculated 108 delay. Additionally/alternatively, transmission process 10 may transmit 122 third message 160 based, at least in part, upon the priority tag (e.g., priority tag 156). Continuing with the above-stated example, the message that user 46 sent to user 48 may contain an attachment (e.g., attachment 154) that must be delivered to user 48 immediately (e.g., which may be indicated by the presence of priority tag 156, which may, for example, be associated via a user selection during creation/transmission of first message 150, or the like). Accordingly, transmission process 10 may detect the presence of priority tag 156 and transmit 122 third message 160 without any delay (e.g., concurrently with second message 158).

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A computer program product residing on a computer readable medium having a plurality of instructions stored thereon which, when executed by a processor, cause the processor to perform operations comprising:
receiving at least a first message, wherein the first message includes a message body and an attachment;
processing the first message to generate at least a second and a third message, wherein the second message is generated based, at least in part, upon the message body and the third message is generated based, at least in part, upon the attachment;
calculating a delay based, at least in part, upon a network condition level;
transmitting the second message; and
transmitting the third message based, at least in part, upon the calculated delay.

2. The computer program product of claim 1, wherein at least the first message further includes a priority tag.

3. The computer program product of claim 2, wherein the instructions for transmitting the third message further comprise instructions for transmitting the third message based, at least in part, upon the priority tag.

4. The computer program product of claim 1, wherein the instructions for processing the first message to generate the at least the second and the third message further comprise instructions for:
generating one or more placeholders based, at least in part, upon the third message; and
modifying the second message to include the one or more placeholders.

5. The computer program product of claim 4, wherein the one or more placeholders are modified to indicate an availability of the third message.

6. The computer program product of claim 1, wherein the instructions for calculating the delay include instructions for calculating the delay based upon, at least in part, a fixed schedule.

7. The computer program product of claim 1, wherein the instructions for calculating the delay include instructions for calculating the delay based upon, at least in part, a minimum transmission limit.

8. A computing system comprising:
a processor;
a memory module coupled with the processor;
a first software module executable by the processor and the memory module, wherein the first software module is configured to receive at least a first message, wherein the first message includes a message body and an attachment;
a second software module executable by the processor and the memory module, wherein the second software module is configured to process the first message to generate at least a second and a third message, wherein the second message is generated based, at least in part, upon the message body and the third message is generated based, at least in part, upon the attachment;
a third software module executable by the processor and the memory module, wherein the third software module is configured to calculate a delay based, at least in part, upon a network condition level;
a fourth software module executable by the processor and the memory module, wherein the fourth software module is configured to transmit the second message; and
a fifth software module executable by the processor and the memory module, wherein the fourth software module is configured to transmit the third message based, at least in part, upon the calculated delay.

9. The computing system of claim 8, wherein at least the first message further includes a priority tag.

10. The computing system of claim 9, wherein the fifth software module, configured to transmit the third message, is further configured to:
transmit the third message based, at least in part, upon the priority tag.

11. The computing system of claim 8, wherein the second software module, configured to process the first message to generate the at least the second and the third message, is further configured to:
generate one or more placeholders based, at least in part, upon the third message; and
modify the second message to include the one or more placeholders.

12. The computing system of claim 11, wherein the one or more placeholders are modified to indicate an availability of the third message.

13. The computing system of claim 8, wherein the third software module, configured to calculate the delay based, at least in part, upon the network condition level, is further configured to calculate the delay based upon, at least in part, a fixed schedule.

14. The computing system of claim 8, wherein the third software module, configured to calculate the delay based, at least in part, upon the network condition level, is further configured to calculate the delay based upon, at least in part, a minimum transmission limit.

15. A computer implemented method comprising:
receiving at least a first message, wherein the first message includes a message body and an attachment;
processing the first message to generate at least a second and a third message, wherein the second message is generated based, at least in part, upon the message body and the third message is generated based, at least in part, upon the attachment;
calculating a delay based, at least in part, upon a network condition level;
transmitting the second message; and
transmitting the third message based, at least in part, upon the calculated delay.

16. The computer implemented method of claim 15, wherein at least the first message further includes a priority tag.

17. The computer implemented method of claim 16, wherein transmitting the third message further comprises transmitting the third message based, at least in part, upon the priority tag.

18. The computer implemented method of claim 15, wherein processing the first message to generate the at least the second and the third message further comprises:
generating one or more placeholders based, at least in part, upon the third message; and
modifying the second message to include the one or more placeholders.

19. The computer implemented method of claim 18, wherein the one or more placeholders are modified to indicate an availability of the third message.

20. The computer implemented method of claim 15, wherein calculating the delay includes calculating a delay based upon, at least in part, a fixed schedule.

21. The computer implemented method of claim 15, wherein calculating the delay includes calculating the delay based upon, at least in part, a minimum transmission limit.
